(19) United States
(12) Patent Application Publication
(10) Pub. No.: US 2007/0036540 A1
(43) Pub. Date: Feb. 15, 2007

(54) POSITIONER WITH SLIP CLUTCH

(76) Inventors: Dino R. Nama, Rancho Santa Margarita, CA (US); Peter A. Regla, Placentia, CA (US); William J. Koziowski JR., Tega Cay, SC (US)

Correspondence Address: LAW OFFICES OF LARRY K. ROBERTS, INC., 2 Park Plaza, Suite 300, Irvine, CA, 92614, US

(21) Appl. No.: 11/463,797

(22) Filed: Aug. 10, 2006

Related U.S. Application Data
(60) Provisional application No. 60/707,666, filed on Aug. 11, 2005.

(51) Int. Cl. G03B 17/00

(52) U.S. Cl. 396/427

(57) ABSTRACT

A positioner system is provided with one or more slip clutch assemblies. A slip clutch may include a torque adjustment mechanism for adjusting a slip torque parameter. A sensor system may be included to re-establish reference positions due to clutch slippage, or monitor absolute and/or incremental position of the head. An energy commutator system may be provided to pass energy through the slip clutch assembly.

### CROSS-REFERENCE TO RELATED APPLICATION

This application claims the benefit of U.S. Provisional Application No. 60/707,666 filed Aug. 11, 2005, hereby incorporated by reference.

### BACKGROUND

This disclosure relates to slip clutches and to positioning systems. Such systems may be used with video or still cameras, or other vision, communication and sensor systems, e.g. scene surveillance and response systems for use on aerial platform trucks and command centers. Other applications may include positioning systems for devices such as remote fire hose control systems, laser-pointing systems and the like.

### BRIEF DESCRIPTION OF THE DRAWINGS

Features and advantages of the disclosure will readily be appreciated by persons skilled in the art from the following detailed description when read in conjunction with the drawing wherein:

FIG. 1 is an isometric view of an exemplary embodiment of a dual camera system with a camera positioning system.

FIG. 1A is an isometric view of an exemplary embodiment of a single camera system with a camera positioning system.

FIG. 2 is an exemplary control system block diagram for the camera system of FIG. 1.

FIG. 3 is an isometric view of an exploded view of an exemplary embodiment of a positioner assembly suitable for the camera system of FIG. 1 or FIG. 2.

FIG. 4A is an isometric view of an exploded view of the positioner assembly of FIG. 3, showing an exemplary pan slip clutch assembly.

FIG. 4B is an isometric view similar to that of FIG. 4A, also showing an exemplary tilt spacer assembly.

FIG. 4C is an isometric view similar to that of FIG. 4B but showing the pan slip clutch assembly and tilt slip clutch assembly in position on the positioner housing.

FIG. 4D is a partially exploded isometric view of an exemplary embodiment of a positioner assembly with the nonmotorized spacer components in exploded view.

FIG. 5 is an exploded isometric view of an exemplary embodiment of a pan slip clutch assembly usable with the camera positioner system of FIGS. 1-4D.

FIG. 6 is an exploded isometric view of an exemplary embodiment of a tilt slip clutch assembly usable with the camera positioner system of FIGS. 1-4D.

FIG. 7 is a top view of an exemplary embodiment of a spiral gear assembly suitable for use in driving the pan and tilt assemblies of FIGS. 5-6.

FIG. 8 is an exploded isometric view of an exemplary embodiment of a pan motor assembly suitable for driving the pan slip clutch assembly of FIG. 5.

FIG. 9 is an exploded isometric view of an exemplary embodiment of a tilt motor assembly suitable for driving the tilt slip clutch assembly of FIG. 6.

FIG. 10 illustrates a U-bracket structure which may be used to connect the camera heads to the positioner housing system.

### DETAILED DESCRIPTION

In the following detailed description and in the several figures of the drawing, like elements are identified with like reference numerals. The figures are not to scale, and relative feature sizes may be exaggerated for illustrative purposes.

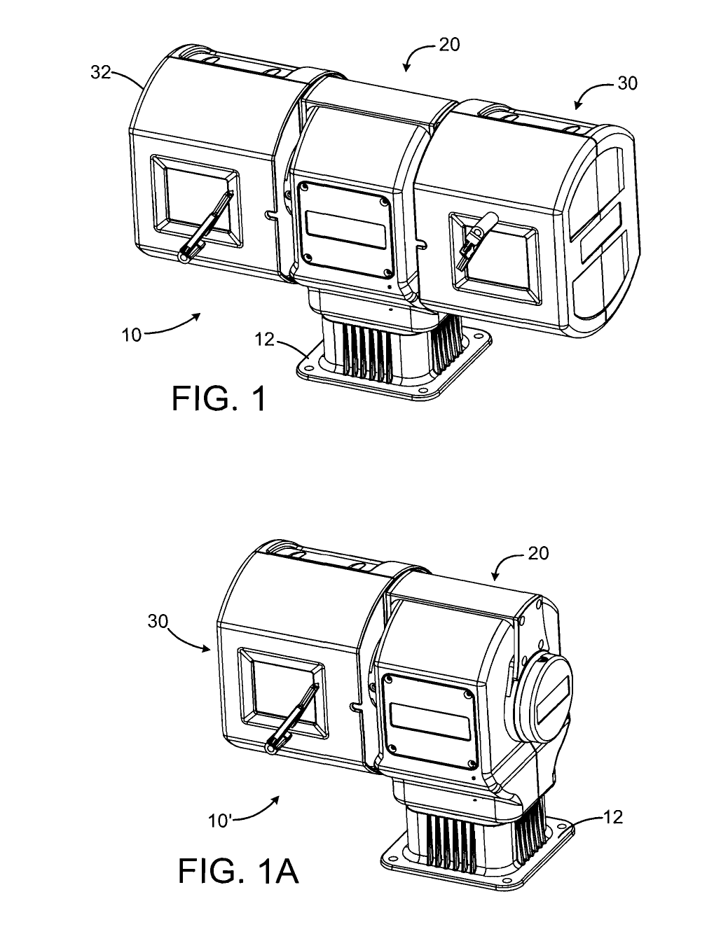

FIG. 1 depicts an exemplary dual camera positioner system 10, including a base 12, a positioner assembly 20 and camera heads 30, 32. The positioner assembly 20 provides motorized drive for panning the heads about a base axis, and for tilting the cameras about a tilt axis transverse to the pan axis. In the event that movement in either axis is obstructed, or the heads or positioner system is manually moved about one or both axes, a slip clutch is provided to allow such movement without damage to the motor drives. Further, the system includes a means to return the heads and the positioner assembly to a home or reference position even after a clutch slippage has occurred. The motors of the positioner system may be electrically powered, but other types of motors may be employed, e.g. pneumatic, hydraulic, water-propelled, linage-driven, by way of example.

It will be appreciated that, while the system 10 of FIG. 1 employs dual cameras, features described herein may also be applied to single camera positioning systems. FIG. 1A illustrates an exemplary single camera positioning system 10′, including a base 12, a positioner assembly 20 and camera head 30.

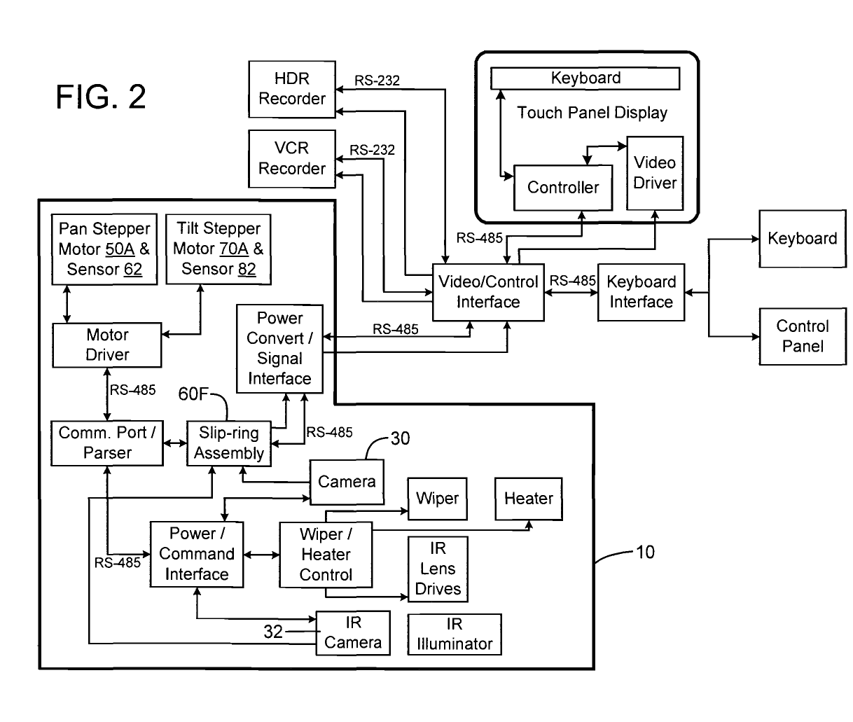

FIG. 2 illustrates an exemplary control system layout for a typical wired system configuration using the camera positioner 10 or 10′, showing exemplary communication signal paths. An exemplary embodiment may be implemented in a surveillance system such as the VideoSentinel system from Intec Video Systems, Inc., Laguna Hills, Calif. FIG. 2 will be described in further detail below.

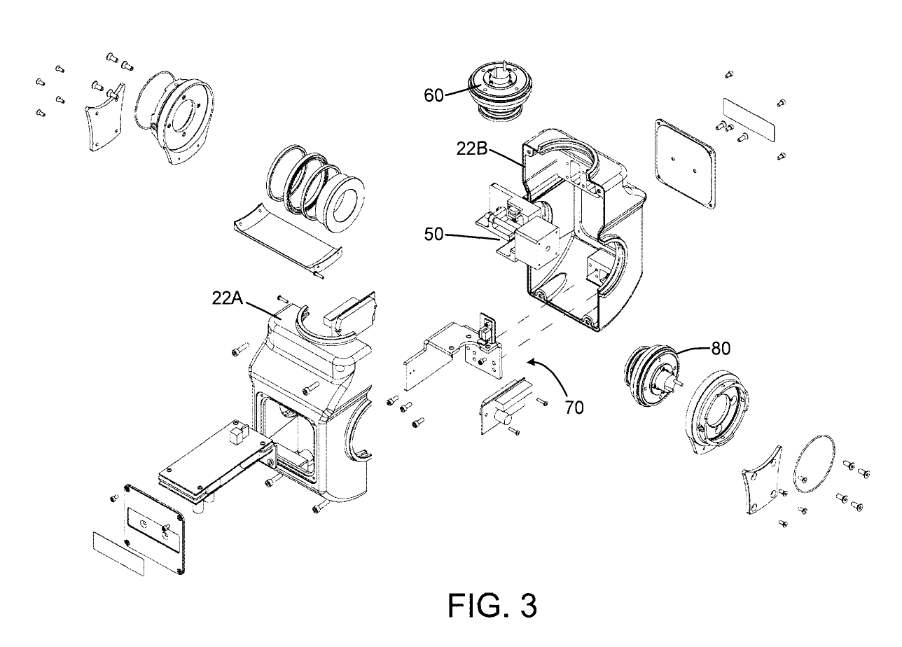

FIG. 3 is an exploded view of an exemplary embodiment of the camera positioner system 20, shown in inverted form. The system includes housing structures 22A-22B into which the motor drive elements are assembled. These include the pan motor assembly 50 and pan slip clutch assembly 60, and tilt motor assembly 70 and tilt slip clutch assembly 70.

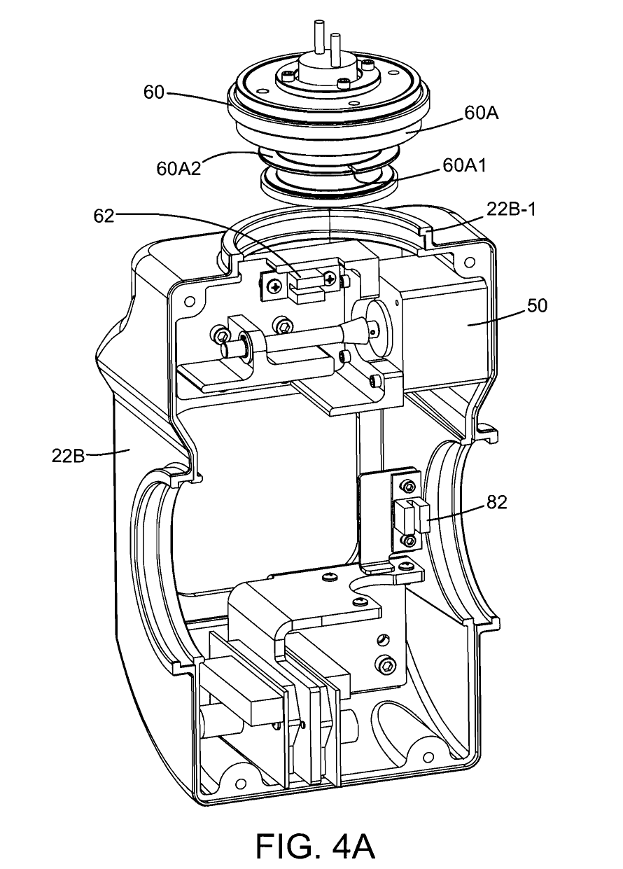

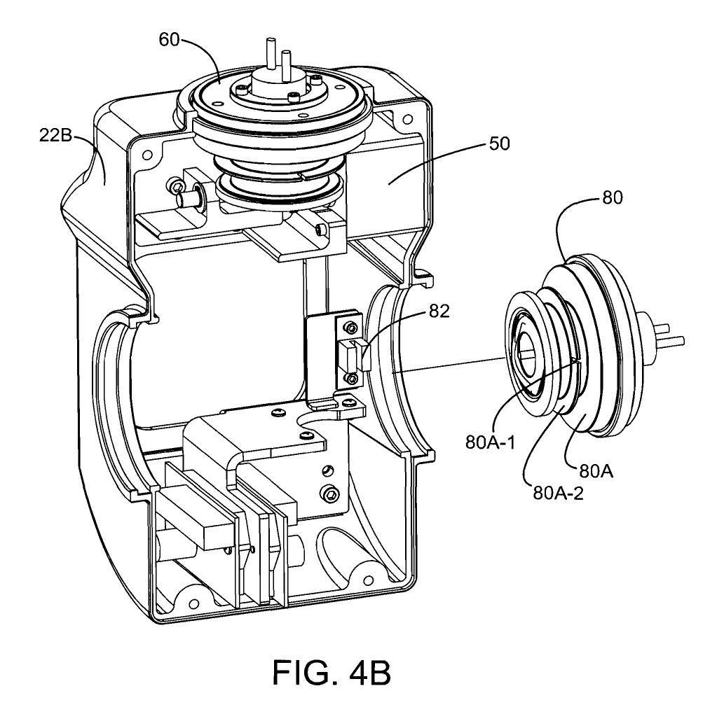

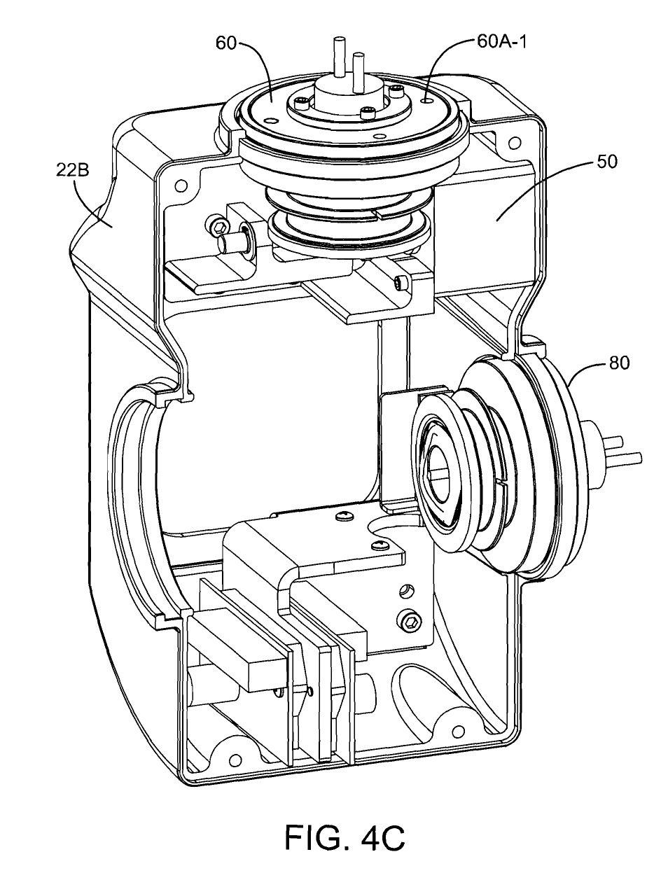

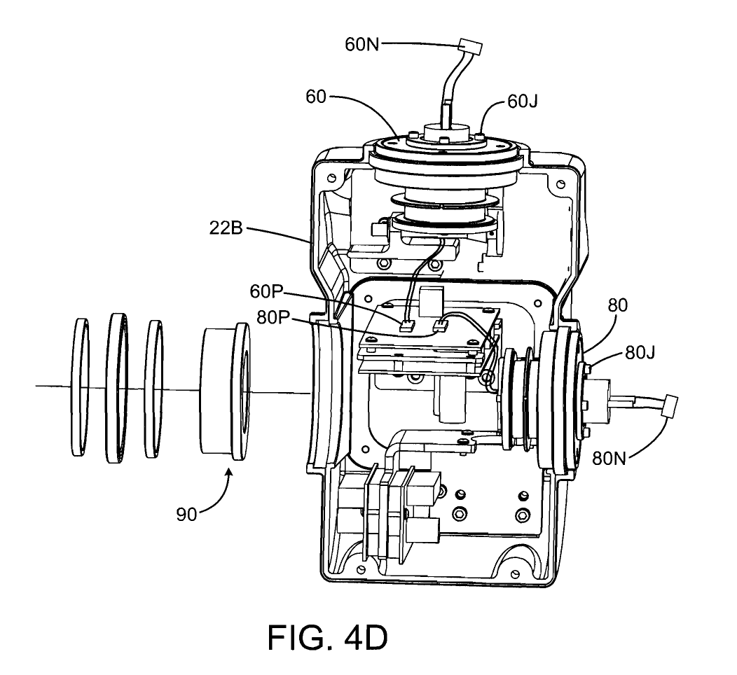

FIG. 4A shows in partially exploded view the housing structure 22B with the pan slip clutch assembly 60. Also visible in FIG. 4A are the optical sensors 62 and 82 which cooperate with features in the spacer assemblies to provide a means to return the camera heads to predetermined positions. In other embodiments, magnetic or mechanical position sensors may alternatively be employed.

FIG. 4B is a view similar to FIG. 4A, but showing the pan slip clutch assembly 60 in proper position on the housing 22B, and showing tilt slip clutch assembly positioned away from its assembly position on housing 22B.

FIG. 4C shows both spacer assemblies 60 and 80 in proper assembled position on housing 22B. The camera head unit 30 (FIG. 1) is subsequently attached to the tilt slip clutch assembly 80. The pan slip clutch assembly 60 is subsequently attached to the base 12. By actuation of the motor drive assemblies 50 and 70, which act on the slip clutch assemblies through respective spiral gear trains as discussed below, the positioner assembly 20 may be rotated about the base, and the camera head unit 30 tilted about a tilt axis.

FIG. 4D shows in partial exploded view the non-motorized spacer assembly 90 which is to be mounted in the housing 22B opposite the slip clutch assembly 80. The second camera head 32 (FIG. 1) may be mounted to the spacer assembly 90. In an exemplary embodiment, the spacer assembly 90 is coupled to the slip clutch assembly 80 so that assembly 90 rotationally moves with assembly 80. Thus, the tilt motor driver 70 provides the drive force for both heads in this exemplary embodiment. Exemplary wiring harnesses 60N, 60P and 80N, 80P may provide electrical connections to the respective slip clutch assemblies 60 and 80.

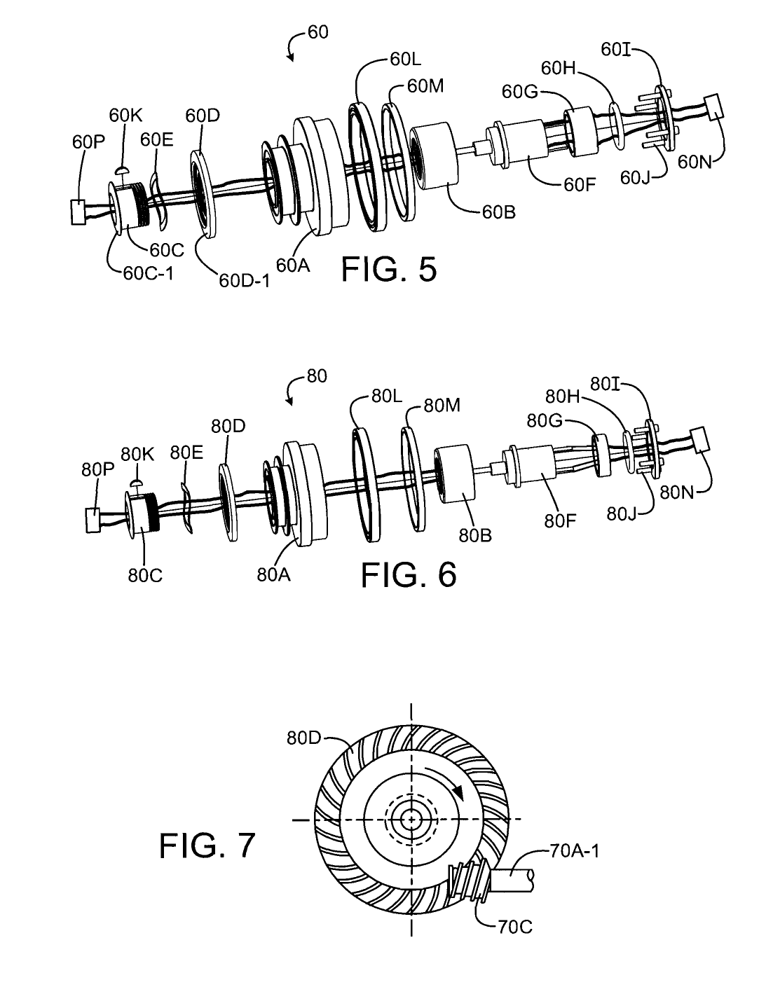

FIGS. 5 and 6 are diagrammatic exploded isometric views of the respective pan and tilt slip clutch assemblies 60, 80. In an exemplary embodiment, salient features of each assembly are similar, and so only assembly 60 is described in detail. Each includes a slip clutch to permit movement of the camera head relative to the positioner housing structures, or of the positioner housing structures relative to the base, without damaging the motor drive elements. The slip clutch assembly 60 includes a number of components. One component is the spacer body 60A, designed with a sleeve aperture to accept a puller 60B that accepts a gear shaft 60C. The spacer body may be secured to a stationary base, allowing the positioner to rotate in relation to the stationary base in an exemplary embodiment. Threaded holes 60A-1 (FIG. 4C) may be used to secure the spacer body to the base. The gear shaft 60C is threaded into a threaded receptacle in the puller 60B.

The gear shaft and the puller together provide a primary means by which a bevel gear 60D is attached to the slip clutch assembly 60. For simplicity, the gear 60D is shown diagrammatically; the gear teeth are not shown in this view. A disc spring 60E is assembled between the bevel gear and the gear shaft to provide a frictional engagement that allows the bevel gear to slip when excessive force is applied. As illustrated in FIGS. 5 and 7, the diameter of the gear shaft 60C and the diameter of the inner gear opening are such that the gear 60D is held concentric to the gear shaft axis, even under slip conditions. This may prevent gear teeth jumping of the engagement of the gear train. The puller may allow a limit on the excessive force to be adjusted, external to the drive mechanism, avoiding disassembly of the drive mechanism to make the adjustment. The puller 60B is designed to accept a slip ring 60F that commutates electrical signals through the spacer body. Slip ring devices are known in the art, e.g. a 24-circuit device, marketed by Techtron as part number SRA-73606-24. The slip ring is assembled to the puller 60B using a spacer 60G and o-ring 60H. The puller 60B is a hollow member, as depicted in FIG. 5, and may receive the slip ring 60F within its interior space. Wiring harnesses 60N and 60P provide exemplary electrical connections on each side of the slip ring device. Other embodiments may omit the slip ring 60F, or allow other elements to be passed through the slip clutch assembly, e.g. water or air in a water or air delivery or water or air powered system.

Primary torque adjustments are made by threading the gear shaft 60C in the puller, sandwiching the disc spring 60E between circumferential lip 60C-1 of the gear shaft and an inner circumferential spring seat 60D-1 formed in the gear 60D, to provide a primary torque setting. The lip 60C-1 and the spring seat 60D-1 provide smooth friction surfaces, as illustrated in FIG. 5. The back surface of the bevel gear as well as the mating surface on the spacer body 60B are also smooth, as illustrated in FIG. 5. A back-up ring or retainer member 60I designed with fine thread fasteners 60J provides fine adjustment of the tension applied to the disc spring 60E under the bevel gear, i.e. a fine torque setting. A torque adjustment mechanism includes means for adjusting an axial compression force on the disc spring exerted by surfaces of the gear shaft and the gear. The fine thread fasteners are received in threaded receptacles in the puller 60C. Fine torque adjustment may be achieved by tightening the fine thread fasteners into the puller to a pre-determined amount of torque, using a tension meter to set the torque depending on the conditions. The back-up ring 60I bears against the spacer body 60B in intimate contact therewith, and as the fasteners are tightened, the puller 60B with the gear shaft 60C is drawn toward the back-up ring, exerting an axial force tending to compress the disc spring 60E between the lip 60C-1 and the seat 60D-1, and increasing the slippage torque, i.e. the torque level needed to be applied to cause slippage. In an exemplary embodiment, the coarse torque adjustment tends to set the lower limit of the slip torque, and the fine torque adjustment through the threaded fasteners permits an infinite adjustment between the torque lower limit and an upper torque limit, to the point in which a very large torque may be needed to result in slippage. In an exemplary embodiment, the fine torque adjustment may be accomplished without contact or physical interaction with the gears, a friction surface of the slip clutch, or the inside of the slip clutch assembly or the positioner assembly, or the motorized drive. For example, the fasteners 60J (and 80J) are available for adjustment on the exterior of the housing structures 22A-22B as depicted, for example, in FIG. 4D, and the motor drives, so that the housing structures do not have to be disassembled for access to the fine torque adjustment. In an exemplary embodiment, the fine torque adjustment of the slip clutch may be performed without removing the slip clutch from the motor drive and without disassembly of the motor drive to gain access to the fine torque adjustment mechanism. Another feature of an exemplary embodiment is that a fine torque adjustment mechanism may be infinitely adjustable through a range of adjustment, be tightening or loosening the fine thread fasteners 60J.

A Woodruff key 60K is used to keep parts of the slip clutch assembly aligned while allowing the bevel gear 60D to slip on the disc spring providing free movement of the camera positioner when excessive force is applied. The key 60K fits into a keyway formed in an unthreaded portion of the gear shaft 60C, as shown in FIG. 5. For example, the key 60K may engage a key slot in the spacer body 60B. The gear would be free to rotate on the gear shaft, except for the frictional tension applied by the disc spring. In an exemplary embodiment, no radial movement during slippage can be transmitted via the gear shaft to the puller, and the puller and its backup plate 60I retains the pre-set slip torque adjustment.

The clutch slip assembly is assembled with a thin race bearing 60L, which is kept with a bearing retainer 60M. The complete slip clutch assembly 60 is assembled into the camera positioner housing, as depicted in FIGS. 4A-4D, with the bearing retainer in contact with the housing structure feature 22B-1 (FIG. 4A).

FIG. 6 illustrates the tilt slip clutch assembly 80, which has components similar to those just discussed regarding assembly 60. The reference numbers 80_{—} correspond to like elements in FIG. 5 with similar letter suffixes 60_. In an exemplary embodiment, the tilt slip-clutch assembly uses a slip ring structure 80F based on a commercially available part, e.g. an 18-circuit part number SRA-73577-18 from Techtron. Wiring harnesses 80N and 80P provide exemplary electrical connections on each side of the slip ring device.

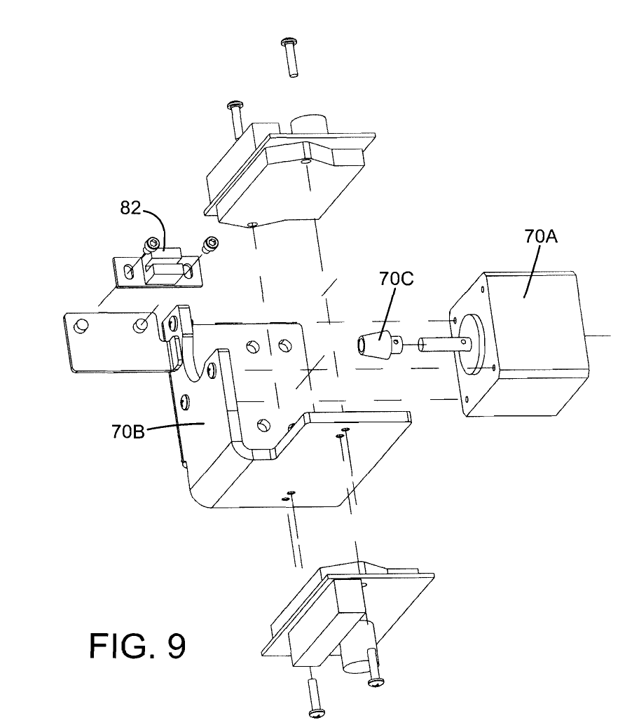

FIG. 7 depicts an exemplary bevel gear and pinion gear arrangement as may be used in the slip clutch assemblies 60 and 80. For the sake of example, FIG. 7 illustrates the bevel gear 80D and a pinion gear 70C attached to a motor shaft 70A1, driven by a motor 70A (FIG. 9). In this embodiment, the gears are spiral mesh gears. In alternate embodiments, other drive trains may be employed, such as pulley or belt drives, by way of example only.

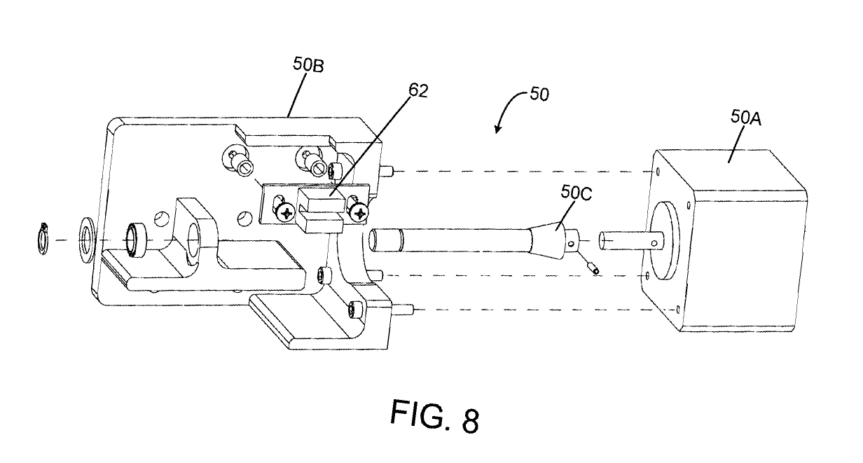

Referring now to FIG. 8, the motor assembly 50 includes in an exemplary embodiment a stepper motor 50A mounted to a motor bracket 50B that secures the assembly to the positioner housing 22B. The stepper motor is assembled with a pinion gear 50C (diagrammatically illustrated in FIG. 8) that meshes with the bevel gear 60D of the slip clutch assembly 60. When energized by commands from a stepper motor driver, the stepper motor turns, thus driving the pinion gear on the bevel gear which results in turning the positioner housing around the bearing and slip clutch assembly 60. The assembly 60 is securely assembled to the positioner housing base mount 12, e.g. with four fasteners through the base mount into the threaded holes 60B-1 (FIG. 4C) in spacer body 60B, in turn attached to a mounting surface.

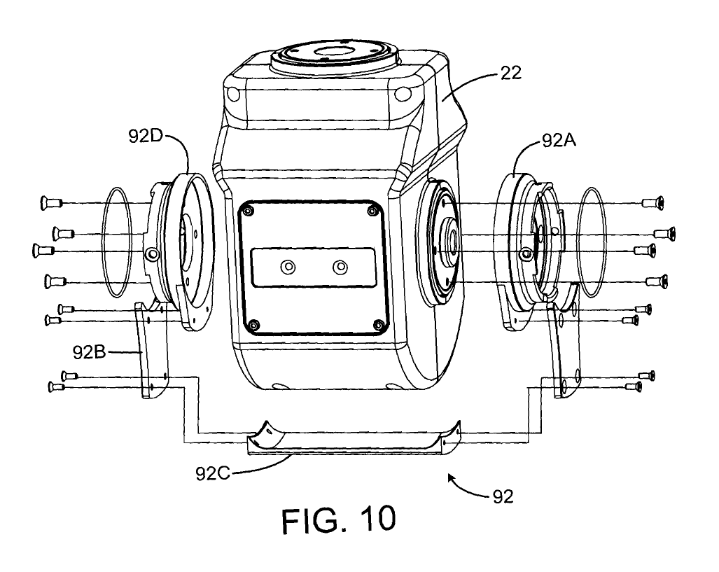

Referring now to FIG. 9, the motor assembly 70 includes in an exemplary embodiment a stepper motor 70A mounted to a motor bracket 70B that secures the assembly to the positioner housing 22B. The stepper motor is assembled with a pinion gear 70C (diagrammatically illustrated in FIG. 9) that meshes with the bevel gear 80D of the slip clutch assembly 80. When energized by commands from the stepper driver, the stepper motor 70A turns, thus driving the pinion gear on the bevel gear which results in turning the camera head 30 around the bearing and slip clutch assembly 80. The assembly 80 is securely assembled to the camera head 30. The camera module 30 is attached to the camera positioner at the hub 92A of a U-bracket 92 (FIG. 10). The U bracket includes several components, two hubs 92A, 92D (one for each camera head), two legs 92B, and a bottom bracket 92C which connects to the respective legs. The hubs are fastened to both the mechanized tilt slip-clutch assembly 80 and the non mechanized spacer 90.

Another feature of the system 10 is the use of optical sensors 62, 82 to sense the position of features on the spacer bodies 60A, 80A. For example, a slot or opening, or other flag feature, 60A1, formed in a peripheral lip 60A2 attached to the spacer body (FIG. 4A). The lip is received within the active region of sensor 62. The optical sensor can sense when the flag feature 60A-1 passes the active region of the sensor, thus, providing a sensor signal indicative of the rotational position of the spacer body 60A relative to the sensor. There can be more than one flag feature in the lip, defining two positions. The position of the flag feature is indicative of the position of the attached camera head 30, since the key 60K, 80K maintains alignment of the spacer body 60A, 80A relative to the camera head. Thus, slippage between the gears 60D, 80D and their corresponding pinion gears does not affect the position of the spacer body relative to the camera head. The sensor signals provide a means of detecting the flag, and hence the corresponding position of the head. By using the flag position as a reference position, the stepper motor drive counters may be reset or zeroed, allowing repositioning of the camera head to a desired position from the reference position. With this sensor embodiment, the system will not know that slippage has occurred. The system may be initiated to return to a reference position by a control signal, e.g. a button push on a control panel.

The pan and tilt optical sensors 62, 82 may be standard components, e.g. a sensor manufactured by Aleph, as part number OJ-141. In an exemplary embodiment, the sensors are interrupter style PCB mounted optosensors. The circuit uses a power and ground circuit through an LED.

The sensor 82 operates in a similar fashion to detect the location of a slot or slots 80A-1 formed in lip 80A-2 of spacer body 80A (FIG. 4B). The sensor information allows the system to re-establish a lost position reference due to clutch slippage.

In an alternate embodiment, the sensors 62, 82 may be implemented as quadrature incremental encoders, and the lip 60A2 replaced or augmented by an encoder ring, with spaced encoder features allowing absolute position and direction of the spacer body, and hence the camera head, to be monitored and controlled. The encoder signals allow the camera positioner system to know if a slippage has occurred, since movement of the spacer body is monitored, and may be compared with motor drive signals to determine whether the spacer body has moved in a direction and amount as commanded. A closed loop control may be employed to move the head to a commanded position if a gear slippage occurs.

Returning to FIG. 2, this diagram illustrates an exemplary embodiment of a surveillance system 100 in which the camera positioner system 10 may be employed. Of course, the system 10 may be employed in various other applications. The system 100 includes several primary components including the System Controller 110, a Video Processor/system processor board 120, the camera positioner assembly, and a System Monitor 130.

Electrical signals including power, video, and data are distributed throughout the system via communication paths for each. Processing functions may be distributed over separate processors using a common interface.

The System Controller 110 provides a human interface to the system and includes a Control Keyboard and a Control Main Boards. The keyboard allows the operator to input operation and programming commands for the system 100. The keyboard and joystick interfaces with the Control Main board to input operator functions and generate operator feedback.

The Control Main board interfaces with the Video Processor/System Processor board 120 to input operator functions and generate operator feedback.

The Video Processor portion of board 120 provides a video control interface circuit that provides communication, video processing and power support for the system. The Video Processor is a multi-camera control board with the capability to auto-detect the type of camera that is attached.

The System Processor portion of board 120 provides a system interface for the System Monitor 130, Camera Positioner Assembly 10 and the System Controller 110. This board 120 receives data from the Control Main board of the System Processor 110. Data is then processed and checked for errors against previous executed, stored commands. If the data meets the software criteria, it is transmitted to the Camera Positioner Assembly 10. Similarly, data from other sources, including feedback from the camera head and video processor modules, is also received and processed.

The system monitor keyboard provides human interface for the System Monitor 130 and its video controller board. This keyboard allows the operator to input operation and programming commands for the System Monitor 130.

The Camera Positioner Assembly 10 includes the Camera Positioner and Camera Modules. The Camera Positioner includes the Power Converter/ signal interface 24A, Camera Control board 24C, and stepper control and motor driver board 24D. Each Camera Module includes a Camera Interface 24B and Heater Interface Board 24E. Together, these autonomous subsystems control the functions of the positioner mechanical systems as well as the plurality of camera module functions.

Positioner systems provide for both pan and tilt axis through motor subsystems including the stepper motors 60A, 80A, optical sensors 62, 82 that provides starting position status, stepper drivers that initialize commands to the stepper motors, and the camera and stepper control boards.

The power converter and signal interface 24A is housed in the base of the Camera Positioner System and functions to change incoming 12 volts to the 24 volts needed for the internal system and to provide an interconnection point between the slip ring assembly of the system and main cable harness.

The camera control and stepper control boards 24C, 24D together provide communication and pan-tilt position support for the stepper motors as well as discrete camera interfaces. The camera control board 24C receives communications from the system processor board and compares the commands to those stored in its processor's memory. The data is checked and if verified, directs the stepper control board to produce pulse data and position control for the motors that drive the mechanical movements.

The stepper control board portions of system 24D provide the profile and position controller for the stepper motor drives that position the pan and tilt axes of the camera positioner. Taking data commands from the camera control board 24C, the stepper control 24D generates the pulse and direction commands for the corresponding stepper motors through each respective stepper driver.

Using dual optical sensors, the limit switch logic circuit amplifies the signal and determines the correct sensor to use based on stepper direction. The limit switch logic circuit provides directional limit inhibits for the tilt axis motor to immediately halt the motor if a limit is reached. The pan axis portion of this circuit provides a signal at a single mechanical point of the pan axis rotation.

The heater-fan-wiper interface board 24E and the camera interface board 24B work in conjunction to provide communication, video processing and power support for each respective camera head. Using the same common interface, these boards translate camera commands from the system processor 120 via the camera controller 24C to camera specific codes.

Among the features of the system 10 are the following. A slip clutch is provided for both pan and tilt axes, allowing slippage between the motor drive and the camera positioner and camera, to minimize risk of damage to the motor drive and other elements Both a coarse slip clutch torque adjustment and a fine torque adjustment are provided. Adjustment of the fine torque setting may be accomplished without disassembly of the slip clutch assembly, e.g. by turning the fine adjustment fasteners. The system provides 360 degree continuous movement around the pan axis. A sensor system permits re-establishment of a lost position reference due to slip clutch slippage, or the monitoring and controlling of the absolute position of the camera head. Slip rings allow power and control signals to be passed through the rotatable slip clutch assemblies.

Although the foregoing has been a description and illustration of specific embodiments of the invention, various modifications and changes thereto can be made by persons skilled in the art without departing from the scope and spirit of the invention. For example, while exemplary embodiments of the positioner system have been described in connection with camera devices, the positioner system may be employed with other attached devices and tools. The attached device may be a passive device, or powered by energy other than electrical energy, e.g. pneumatic, hydraulic, water-propelled, linkage-driven or the like. Slip ring assemblies for commutating pneumatic fluid or gas are commercially available. One such application may be a remote controlled fire hose positioner. The fire hose positioner may allow a water flow system through the slip clutch, which would provide a feature allowing the system to stop if jammed against a building, for example. The slip clutch in an exemplary embodiment provides a hollow center, which allows, for example, a slip ring or other feature to be accommodated.

What is claimed is:

1. A camera positioner system, comprising:
a base;
a camera head for providing electronic image signals;
a positioner assembly, including a motorized drive for panning the head about a base axis, and a slip clutch assembly allowing relative movement between the base and the camera head without damage to the motorized drive in the event of obstruction or manual movement of the head, the slip clutch assembly including a commutation assembly for commutating the electronic image signals through the slip clutch assembly, permitting rotation of the camera head about the base axis while passing the image signals from the head to the base.

2. The system of claim 1, wherein the slip clutch assembly is adapted to allow 360 degrees of rotation of the camera head about the base axis.

3. The system of claim 1, wherein the commutation assembly comprises a slip ring assembly.

4. The system of claim 1, wherein the camera head is electrically powered, and the commutation assembly further commutates electrical power.

5. A positioner system, comprising:
a base;
a head for attachment of a working device powered by an energy source;
a positioner assembly, including a motorized drive for rotating the head about a base axis, and a slip clutch assembly allowing relative slip movement between the base and the head without damage to the motorized drive in the event of obstruction or manual movement of the head, the slip clutch including a commutation assembly for commutating energy from the energy source through the slip clutch assembly, permitting rotation of the head about the base axis while passing said energy.

6. The system of claim 5, wherein the slip clutch assembly is adapted to allow 360 degrees of rotation of the head about the base axis.

7. The system of claim 5, wherein the commutation assembly comprises a slip ring assembly.

8. The system of claim 5, wherein the working device is electrically powered, and the commutation assembly further commutates electrical power.

9. The system of claim 5, wherein the working device is pneumatically powered.

10. A positioner system, comprising:
a base;
a head for attachment of a working device or tool;
a positioner assembly, including a motorized drive for rotating the head about a base axis, and a slip clutch assembly allowing relative slip movement between the base and the head without damage to the motorized drive in the event of obstruction or manual movement of the head, the slip clutch assembly including a torque adjustment mechanism operable external to the positioner assembly for adjusting a slip torque parameter of the slip clutch assembly to control a torque amount needed to result in said relative slip movement.

11. The system of claim 10, wherein the slip clutch assembly is adapted to allow 360 degrees of rotation of the head about the base axis.

12. The system of claim 10, wherein said torque adjustment mechanism is adjustable without disassembly of the slip clutch assembly.

13. The system of claim 10, wherein the torque adjustment mechanism includes a coarse slip clutch torque adjustment mechanism and a fine slip clutch torque adjustment mechanism.

14. The system of claim 13, wherein said fine slip clutch torque adjustment mechanism includes a plurality of threaded fasteners which engage threaded receptacles in a puller member.

15. The system of claim 10, wherein the working device is a camera providing electronic image signals, and the slip clutch assembly includes a commutation assembly for commutating the electronic camera image signals through the slip clutch assembly, permitting rotation of the head about the base axis while passing the image signals from the head to the base.

16. The system of claim 10, wherein the motorized drive includes a gear member, and the slip clutch assembly includes a gear shaft member, and a disc spring member captured between the gear shaft member and a spring seat in the gear member, and the torque adjustment mechanism comprises means for adjusting an axial compression force on the disc spring member exerted by surfaces of the gear shaft member and the gear member.

17. The system of claim 16, wherein the slip clutch member includes a spacer body member and the torque adjustment mechanism includes a puller member attached to the gear shaft member, a retainer member bearing against the spacer body member, and a threaded fastener configuration for engaging the puller member.

18. A positioner system, comprising:
a base;
a head for attachment of a working device or tool;
a positioner assembly, including a motorized drive for rotating the head about a base axis, a slip clutch assembly allowing relative slip movement between the base and the head without damage to the motorized drive in the event of obstruction or manual movement of the head, and means for returning the head and the positioner assembly to a home or reference position after a clutch slippage has occurred.

19. The system of claim 18, wherein the slip clutch assembly is adapted to allow 360 degrees of rotation of the head about the base axis.

20. The system of claim 18, wherein said means for returning the head and the positioner assembly to a home or reference position comprises a sensor system which permits re-establishment of a lost position reference due to clutch slippage.

21. The system of claim 18, wherein the working device is a camera system providing electronic image signals, and the slip clutch assembly includes a commutation assembly for commutating the electronic image signals through the slip clutch assembly, permitting rotation of the head about the base axis while passing the image signals from the head to the base.

22. A positioner system, comprising:
a base;
a positioner assembly;
a head;
the positioner assembly adapted to provide motorized drive for panning the head about a base axis through 360 degrees, and for tilting the head about a tilt axis transverse to the pan axis, the positioner assembly further including a slip clutch system adapted to accommodate slip movement about one or both the base axis and the tilt axis, in the event that movement in either axes is obstructed, or the head or positioner system is manually moved about one or both axes;
means for returning the heads and the positioner assembly to a home or reference position.

23. The system of claim 22, further comprising a camera mounted to said head providing electronic image signals, and wherein the slip clutch assembly system includes a commutation assembly system for commutating the electronic image signals through the slip clutch assembly system, permitting rotation of the head about the base axis and the tilt axis while passing the image signals from the head to the base.

24. A slip clutch assembly allowing relative slip movement between a drive member and a body member on a clutch axis without damage to the drive member in the event of application of a slip torque, the slip clutch assembly including a torque adjustment mechanism for adjusting an axial compression force on the drive member, said torque adjustment mechanism operable without disassembly of the slip clutch assembly for adjusting a slip torque parameter of the slip clutch assembly to control a torque amount needed to result in said relative slip movement.

25. The slip clutch assembly of claim 24, wherein the drive member is adapted for 360 degrees of rotation about the clutch axis.

26. The slip clutch assembly of claim 24, further comprising:
a commutation assembly for commutating electrical signals or power through the slip clutch assembly during rotation.
